(19) United States
(12) Patent Application Publication
(10) Pub. No.: US 2002/0008811 A1
(43) Pub. Date: Jan. 24, 2002

(54) Adjustable liquid crystal display device

(75) Inventors: Chun-Ting Liao, Taipei (TW); Chao-Chin Huang, Chiayi Hsien (TW); Wei-Chih Chen, Pingtung (TW)

Correspondence Address: Richard P. Berg, Ladas & Parry, Suite #2100, 5670 Wilshire Boulevard, Los Angeles, CA, 90036-5679, US

(73) Assignee: Acer Communications and Multimedia Inc.

(21) Appl. No.: 09/905,789

(22) Filed: Jul. 13, 2001

(30) Foreign Application Priority Data
Jul. 24, 2000 (TW) 89114711

(51) Int. Cl. G02F 1/1335

(52) U.S. Cl. 349/96

(57) ABSTRACT

An adjustable liquid crystal display device comprises a liquid crystal display (refers to LCD), a light source, a first polarizer, and a second polarizer. The LCD has a light-receiving surface and a light-emitting surface, and shows the image and the characters. The light source emits a light toward the light-receiving surface of the liquid crystal display. The first polarizer locates between the light source and the LCD, and converts the light into a polarized light that can pass through the LCD. The second polarizer locates on the same side with the light-emitting surface of the liquid crystal display.

The present invention is characterized in that the adjustable liquid crystal display device further comprises an adjustable mechanism. The first polarizer and the second polarizer form relative rotation by utilizing the adjustable mechanism. The angle included by a first polarizing axis of the first polarizer and a second polarizing axis of the second polarizer is varied by rotating the adjustable mechanisms, the characters and the background on the LCD will display different tint and contrast.

### BACKGROUND OF THE INVENTION

1. Field of the Invention

The present invention relates to an adjustable LCD display device, and especially relates to an adjustable LCD display device having an adjustable mechanism, two polarizers and a LCD locating between the two polarizers. As the two polarizers make a relative rotation by the adjustable mechanism, either of the contrast and the tint of the characters and the background on the LCD change.

2. Description of the Prior Art

FIG. 1 is a cross-sectional view of a conventional LCD device. The conventional LCD device includes a LCD 7, a first polarizer 2, a second polarizer 6 and a light source 1. The LCD 7 has a first glass 3, a liquid crystal layer 4 and a second glass 5, wherein the liquid crystal layer 4 is sandwiched between the first glass 3 and the second glass 5. The first polarizer 2 is positioned under the first glass 1, and the second polarizer 6 is positioned over the second glass 5. The light source is positioned near one side of the first polarizer 2 and emits an unpolarized light toward the LCD 7.

As the light source 1 emits an unpolarized light and the LCD 7 receives an image data, the first polarizer 2 will convert the unpolarized light to a linear polarized light. Next, the linear polarized light will pass through the second polarizer 6. Finally, the characters and the background shown on the LCD device have unchangeable tint and contrast.

However, the first polarizer 2 and the second polarizer 6 are respectively fixed under and over the LCD 7. Once they are set, these kinds of display device are not easy to change the brightness, contrast and the tint. However, the present consuming electronics are requested to be changeful and led by consumers, so the conventional LCD device is unable to satisfy the consumers who like the new and loathe the old.

### SUMMARY OF THE INVENTION

An object of the present invention is to solve the above mentioned problems of the prior art by providing an adjustable liquid crystal display (refer to LCD) device. The adjustable LCD device comprises a LCD, a light source, a first polarizer and a second polarizer. The LCD comprises a light-receiving surface and a light-emitting surface, wherein the light-emitting surface displays the image and the characters. The light source emits an original light beam toward the light-receiving surface of the LCD. The first polarizer is positioned between the light source and the LCD for converting the original light beam into a polarized light, which passes through the LCD. The second polarizer is positioned on the light-emitting surface of the LCD. The present invention further comprises an adjustable mechanism. The first polarizer and the second polarizer can make a relative rotation by the adjustable mechanism. As an angle included by a first polarizing axis of the first polarizer and a second polarizing axis of the second polarizer can be varied by the adjustable mechanism, the characters and the background on the LCD can be displayed in different tint and contrast. Moreover, user can change the tint and the contrast of the characters and the background on the LCD device at user's own will.

### BRIEF DESCRIPTION OF THE DRAWINGS

This and other objects and features of this invention will become clear from the following description, taken in conjunction with the preferred embodiments with reference to the accompanied drawings in which:

FIG. 1 is a cross-sectional view of a conventional LCD device;

FIG. 2 is a cross-sectional view of an adjustable LCD device of the first embodiment of the present invention;

FIG. 3 is a cross-sectional view of an adjustable LCD device of the second embodiment of the present invention;

FIG. 4 is a cross-sectional view of an adjustable LCD device of the third embodiment of the present invention;

FIG. 5 is a view of a cellular phone utilizing the adjustable LCD device of the present invention.

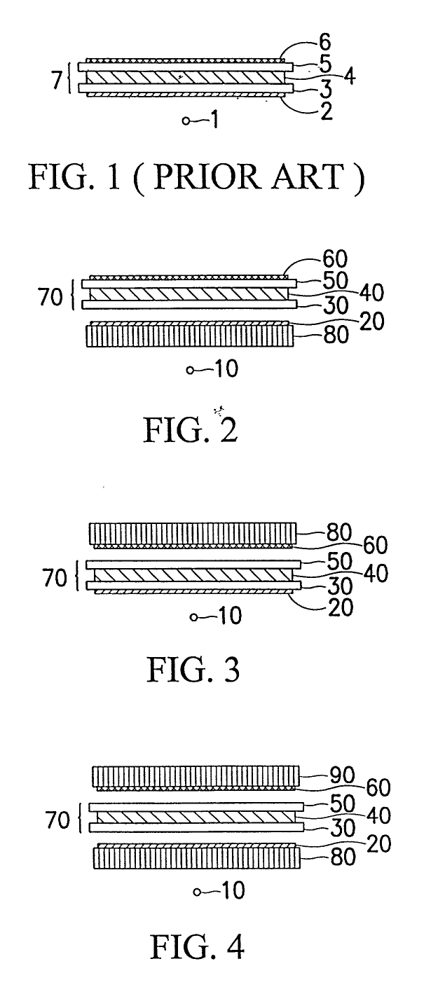

### DESCRIPTION OF THE PREFERRED EMBODIMENTS

First Embodiment

FIG. 2 is a cross-sectional view of an adjustable liquid crystal display (refer to LCD) device of the first embodiment of the present invention.

The adjustable LCD device comprises a liquid crystal display (refer to LCD) 70, a light source 10, a first polarizer 20 and a second polarizer 60.

The LCD 70 comprises a first glass 30, a liquid crystal layer 40 and a second glass 50, wherein the first glass 30 includes a light-receiving surface and the second glass 50 includes a light-emitting surface for displaying the image data. The light source 10 emits an original light beam toward the LCD 70. The light-receiving surface of the first glass 30 faces the light source 10, and the light-emitting surface of the second glass 50 emits an image light toward users.

As shown in FIG. 2, the first polarizer 20 is positioned between the LCD 70 and the light source 10. The first polarizer 20 is assembled with an adjustable mechanism 80, and a space forms between the first polarizer 20 and the first glass 30 of the LCD 70. The first polarizer 20 converts the original light beam emerging from the light source 10 into a first polarized light, which is able to pass through the LCD 70.

As shown in FIG. 2, the second polarizer 60 is positioned on the same side as the light-emitting surface of the second glass 50 of the LCD 70. The second polarizer 60 converts the first polarized light passing through the LCD 70 into a second polarized light, which has the same polarization direction with the polarized axis of the second polarizer 60.

The characteristic of the embodiment of the present invention is that as the first polarizer 20 and the second polarizer 60 make a relative rotation by adjusting the adjustable mechanism 80, either of the contrast and the tint of the characters and the background on the LCD change. In other words, as the angle included by a first polarizing axis of the first polarizer 20 and a second polarizing axis of the second polarizer 60 is varied by the adjustable mechanism 80, the characters and the background on the LCD 70 will display different tint and contrast.

In the embodiment, the adjustable mechanism 80 can further assemble with a LCD cover (not shown) of the LCD device to reach the purposes of easy design and adjust.

Second Embodiment

FIG. 3 is a cross-sectional view of an adjustable LCD device of the second embodiment of the present invention.

The adjustable LCD device comprises a liquid crystal display (refer to LCD) 70, a light source 10, a first polarizer 20 and a second polarizer 60.

The LCD 70 comprises a first glass 30, a liquid crystal layer 40 and a second glass 50, wherein the first glass 30 includes a light-receiving surface and the second glass 50 includes a light-emitting surface for displaying the image data. The light source 10 emits an original light beam toward the LCD 70. The light-receiving surface of the first glass 30 faces the light source 10, and the light-emitting surface of the second glass 50 emits an image light toward users.

As shown in FIG. 3, the first polarizer 20 is positioned between the LCD 70 and the light source 10. The first polarizer 20 is positioned on the same side as the light-receiving surface of the first glass 30 of the LCD 70. The first polarizer 20 converts the original light beam emerging from the light source 10 into a first polarized light, which is able to pass through the LCD 70.

As shown in FIG. 3, the second polarizer 60 is positioned on the same side as the light-emitting surface of the second glass 50 of the LCD 70. The second polarizer 60 is assembled with an adjustable mechanism 80, and a space forms between the second polarizer 60 and the second glass 50 of the LCD 70. The second polarizer 60 converts the first polarized light passing through the LCD 70 into a second polarized light, which has the same polarization direction with the polarized axis of the second polarizer 60.

The characteristic of the embodiment of the present invention is that as the first polarizer 20 and the second polarizer 60 make a relative rotation by adjusting the adjustable mechanism 80, either of the contrast and the tint of the characters and the background on the LCD change. In other words, as the angle included by a first polarizing axis of the first polarizer 20 and a second polarizing axis of the second polarizer 60 is varied by the adjustable mechanism 80, the characters and the background on the LCD 70 will display different tint and contrast.

In the embodiment, the adjustable mechanism 80 can further assemble with a backlight holder (not shown) of the LCD device to reach the purposes of easy design and adjust.

Third Embodiment

FIG. 4 is a cross-sectional view of an adjustable LCD device of the third embodiment of the present invention.

The adjustable LCD device comprises a liquid crystal display (refer to LCD) 70, alight source 10, a first polarizer 20 and a second polarizer 60.

The LCD 70 comprises a first glass 30, a liquid crystal layer 40 and a second glass 50, wherein the first glass 30 includes a light-receiving surface and the second glass 50 includes a light-emitting surface for displaying the image data. The light source 10 emits an original light beam toward the LCD 70. The light-receiving surface of the first glass 30 faces the light source 10, and the light-emitting surface of the second glass 50 emits an image light toward users.

As shown in FIG. 4, the first polarizer 20 is positioned between the LCD 70 and the light source 10. The first polarizer 20 is assembled with a first adjustable mechanism 80, and a space forms between the first polarizer 20 and the first glass 30 of the LCD 70. The first polarizer 20 converts the original light beam emerging from the light source 10 into a first polarized light, which is able to pass through the LCD 70.

As shown in FIG. 4, the second polarizer 60 is positioned on the same side as the light-emitting surface of the second glass 50 of the LCD 70. The second polarizer 60 is assembled with a second adjustable mechanism 90, and a space forms between the second polarizer 60 and the second glass 50 of the LCD 70. The second polarizer 60 converts the first polarized light passing through the LCD 70 into a second polarized light, which has the same polarization direction with the polarized axis of the second polarizer 60.

The characteristic of the embodiment of the present invention is that as the first polarizer 20 and the second polarizer 60 make a relative rotation by adjusting the first adjustable mechanism 80 and the second adjustable mechanism 90, either of the contrast and the tint of the characters and the background on the LCD change. In other words, as the angle included by a first polarizing axis of the first polarizer 20 and a second polarizing axis of the second polarizer 60 is varied by relative rotation, the characters and the background on the LCD 70 will display different tint and contrast.

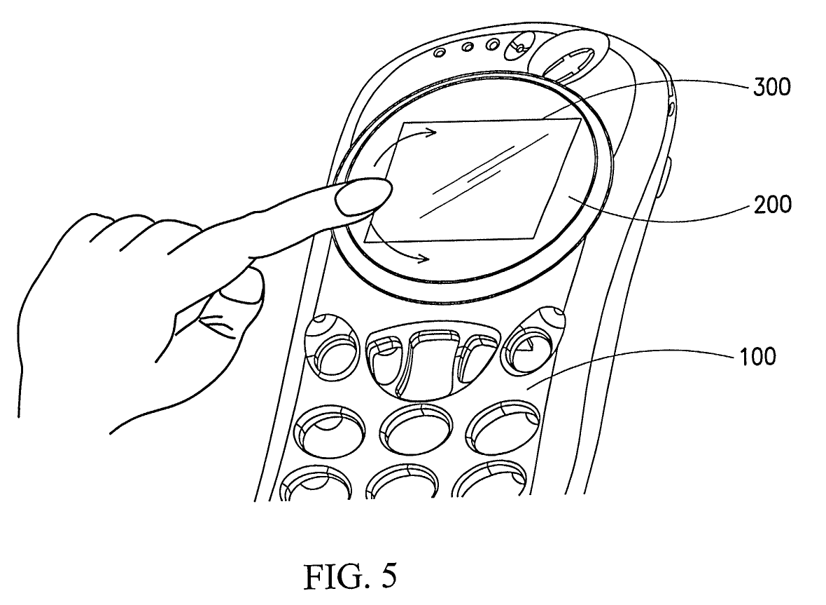

FIG. 5 is a view of a cellular phone utilizing the adjustable LCD device of the present invention. As shown in FIG. 5, as a user rotates the rotation mechanism, the polarizing angles of the first polarizer 20 and the second polarizer 60 vary. Consequently, the characters and background shown on the liquid crystal display device 300 change their tint and contrast upon the rotation of the rotation mechanism.

In all the embodiments of the present invention, as the first polarizer and the second polarizer make a relative rotation, the characters and the background on the liquid crystal display device change their tint and contrast, such as black characters and white background, white characters and black background, orange characters and blue background, yellow characters and purple background . . . etc. At the present day, the contrast ratio (refer to CR) of the conventional LCD device utilizing an electro-fluorescence lamp is about 11:1. However, in some of the embodiments with some specific angle of the present invention, the CR could raise to 20:1. The result is better than the conventional LCD.

In all the embodiments of the present invention, the light source comprises one selective of an electro-fluorescence lamp and a light emitting diode (refers to LED). The adjustable LCD device can be applied to a mobile phone, a personal digital assistant (refers to PDA) and a palm video game . . . etc.

While the preferred forms of the present invention have been described, it is to be understood that modifications will be apparent to those skilled in the art without departing from the spirit of the invention. The scope of the invention, therefore, is to be determined solely by the following claims.

What is claimed is:

1. An adjustable liquid crystal display device comprising:
a liquid crystal display for displaying the image and the characters, the liquid crystal display having a light-receiving surface and a light-emitting surface;
a light source emitting a light toward the light-receiving surface of the liquid crystal display;
a first polarizer locating between the light source and the liquid crystal display, and converting the light into a polarized light which can pass through the liquid crystal display;
a second polarizer locating on the same side with the light-emitting surface of the liquid crystal display; and
an adjustable mechanism connecting with the first polarizer, wherein as the angle included by a first polarizing axis of the first polarizer and a second polarizing axis of the second polarizer is varied by utilizing the adjustable mechanism to make a relative rotation, the characters and the background on the LCD will display different tint and contrast.

2. The adjustable liquid crystal display device as claimed in claim 1, wherein the liquid crystal display further comprises a first glass, a liquid crystal layer and a second glass, wherein the first glass faces toward the light source.

3. The adjustable liquid crystal display device as claimed in claim 2, wherein the second polarizer is positioned on the second glass of the liquid crystal display device.

4. An adjustable liquid crystal display device comprising:
a liquid crystal display for displaying the image and the characters, the liquid crystal display having a light-receiving surface and a light-emitting surface;
a light source emitting a light toward the light-receiving surface of the liquid crystal display;
a first polarizer locating between the light source and the liquid crystal display, and converting the light into a polarized light which can pass through the liquid crystal display;
a second polarizer locating on the same side with the light-emitting surface of the liquid crystal display; and
an adjustable mechanism connecting with the second polarizer, wherein as the angle included by a first polarizing axis of the first polarizer and a second polarizing axis of the second polarizer is varied by utilizing the adjustable mechanism to make a relative rotation, the characters and the background on the LCD will display different tint and contrast.

5. The adjustable liquid crystal display device as claimed in claim 4, wherein the liquid crystal display further comprises a first glass, a liquid crystal layer and a second glass, wherein the first glass faces toward the light source.

6. The adjustable liquid crystal display device as claimed in claim 5, wherein the first polarizer is positioned on the first glass of the liquid crystal display device.

7. An adjustable liquid crystal display device comprising:
a liquid crystal display for showing the image and the characters, the liquid crystal display having a light-receiving surface and a light-emitting surface;
a light source emitting a light toward the light-receiving surface of the liquid crystal display;
a first polarizer locating between the light source and the liquid crystal display, and converting the light into a polarized light which can pass through the liquid crystal display;
a second polarizer locating on the same side with the light-emitting surface of the liquid crystal display;
a first adjustable mechanism connecting with the first polarizer; and
a second adjustable mechanism connecting with the second polarizer; wherein
as the angle included by a first polarizing axis of the first polarizer and a second polarizing axis of the second polarizer is varied by rotating the first and second adjustable mechanisms, the characters and the background on the LCD will display different tint and contrast.

8. An adjustable liquid crystal display device comprising:
a liquid crystal display for showing the image and the characters, the liquid crystal display having a light-receiving surface and a light-emitting surface;
a light source emitting a light toward the light-receiving surface of the liquid crystal display;
a first polarizer locating between the light source and the liquid crystal display, and converting the light into a polarized light which can pass through the liquid crystal display;
a second polarizer locating on the same side with the light-emitting surface of the liquid crystal display; and
an adjustable mechanism locating inside the liquid crystal display; wherein
as the angle included by a first polarizing axis of the first polarizer and a second polarizing axis of the second polarizer is varied by rotating the adjustable mechanisms, the characters and the background on the LCD will display different tint and contrast.
